(19) United States
(12) Patent Application Publication
(10) Pub. No.: US 2005/0055199 A1
(43) Pub. Date: Mar. 10, 2005

(54) Method and apparatus to provide a hierarchical index for a language model data structure

(75) Inventors: Ivan Ryzchachkin, Sarov (RU); Alexander Kibkalo, Sarov (RU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/492,857

(22) PCT Filed: Oct. 19, 2001
(86) PCT No.: PCT/RU01/00431

(51) Int. Cl. G06F 17/28

(52) U.S. Cl. 704/4

(57) ABSTRACT

A method for storing bigram word indexes of a language model for a consecutive speech recognition system (200) is described. The bigram word indexes (321) are stored as a common two-byte base with a specific one-byte offset to significantly reduce storage requirements of the language model data file. In one embodiment the storage space required for storing the bigram word indexes (321) sequentially is compared to the storage space required to store the bigram word indexes as a common base with specific offset. The bigram word indexes (321) are then stored so as to minimize the size of the language model data file.

### FIELD OF THE INVENTION

The present invention relates generally to statistical language models used in consecutive speech recognition (CSR) systems, and more specifically to the more efficient organization of such models.

### BACKGROUND OF THE INVENTION

Typically, a consecutive speech recognition system functions by propagating a set of word sequence hypotheses and calculating the probability of each word sequence. Low probability sequences are pruned while high probability sequences are continued. When the decoding of the speech input is completed, the sequence with the highest probability is taken as the recognition result. Generally speaking a probability-based score is used. The sequence score is the sum of the acoustic score (sum of acoustic probability logarithms for all minimal speech units—phones or syllables) and the linguistic score (sum of the linguistic probability logarithms for all words of the speech input).

CSR systems typically employ a statistical n-gram language model to develop the statistical data. Such a model calculates the probability of observing n successive words in a given domain because in practice a current word may be assumed to depend on its n previous words. A unigram model calculates P(w) which is the probability for each word w. A bigram model uses unigrams and the conditional probability P(w₂ |w₁) which is the conditional probability of w₂ given the previous word is w, for each word w, and w₂. A trigram model uses unigrams, bigrams, and the conditional probability P(w₃ |w₂, w₁) which is the conditional probability of w₃ given that the two previous words are w, and w₂ for each word w, W2 and ws. The values of bigram and trigram probabilities are calculated during a language model training process that requires a large amount of text data, a text corpus. The probability may be accurately estimated if the word sequence occurs comparatively often in the training data. Such probabilities are termed existing. For n-gram probabilities that are not existing, a backoff formula is used to approximate the value.

Such statistical language models are especially useful for large vocabulary CSR systems that recognize arbitrary speech (dictation task). For example, theoretically for a dictionary of 50,000 words there would be 50,000 unigrams, billions (50,000²) of bigrams, and more than 100 trillion (50,000³) trigrams. In practice the numbers are significantly reduced because bigrams and trigrams exist only for word pairs and word triples that occur relatively often. For example, in the English language, for the well-known Wall Street Journal (WSJ) task with a dictionary of 20,000 words, only seven million bigrams and 14 million trigrams are used in the language model. These numbers depend on the particular language, task domain, and the size of the text corpus used to develop the language model. Nevertheless, this is still an enormous amount of data, and the size of the language model database, and how the data is accessed, significantly impact the viability of the speech recognition system. A typical language model data structure is described below in reference to FIG. 1.

FIG. 1 illustrates a trigram language model data structure in accordance with the prior art. Data structure 100, shown in FIG. 1, contains a unigram level 105, a bigram level 110, and a trigram level 115. The notation P(w₃₁|w₂, w₁), where w₃, w₂, and w₁ are word indexes, denotes the probability of word w₃, given that its previous two words are word w₁ followed by word w₂. To determine such a probability, wl is located in the unigram level 105, the unigram level contains a link to the bigram level. A pointer is obtained to the corresponding bigram level 110 and the bigram corresponding to wl|w2 is located, the bigram level contains a link to the trigram level. From here a pointer to the corresponding trigram level 115 is obtained and the trigram P(w₃ |w₂, w₁), is retrieved. Typically the unigrams, bigrams, and trigrams of the prior art language model data structure are all stored in a simple sequential order and searched sequentially. Therefore, when searching for a bigram, for example, the link to the bigram level from the unigram level is obtained and the bigrams are searched sequentially to obtain the word index for the second word.

Speech recognition systems are being implemented more often on small, compact computing systems such as personal computers, laptops, and even handheld computing systems. Such systems have limited processing and memory storage capabilities so it is desirable to reduce the memory required to store the language model data structure.

### BRIEF DESCRIPTION OF THE DRAWINGS

The present invention is illustrated by way of example, and not limitation, by the figures of the accompanying drawings in which like references indicate similar elements and in which:

FIG. 1 illustrates a trigram language model data structure in accordance with the prior art;

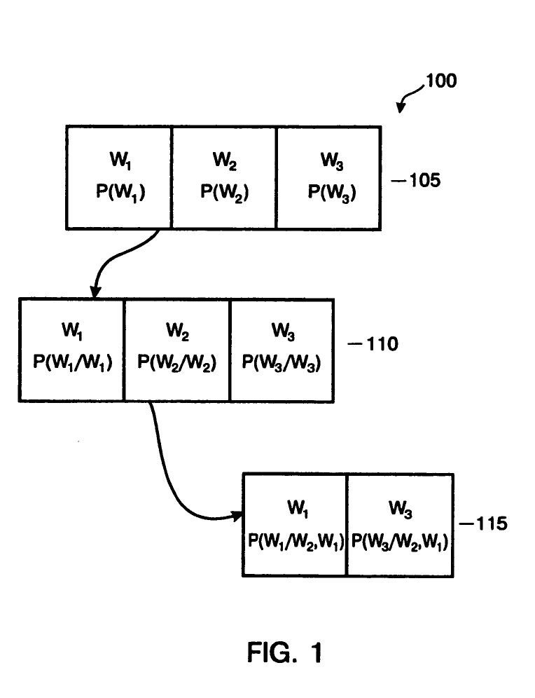

FIG. 2 is a diagram illustrating an exemplary computing system 200 for implementing a language model database for a consecutive speech recognition system in accordance with the present invention;

FIG. 3 illustrates a hierarchical storage structure in accordance with one embodiment of the present invention; and

FIG. 4 is a process flow diagram in accordance with one embodiment of the present invention.

### DETAILED DESCRIPTION

An improved language model data structure is described. The method of the present invention reduces the size of the language model data file. In one embodiment the control information (e.g., word index) for the bigram level is compressed by using a hierarchical bigram storage structure. The present invention capitalizes on the fact that the distribution of word indexes for bigrams of a particular unigram are often within 255 indexes of one another (i.e., the offset may be represented by one byte). This allows many word indexes to be stored as a two-byte base with a one-byte offset in contrast to using three bytes to store each word index. The data compression scheme of the present invention is practically applied at the bigram level. This is because each unigram has, on average, approximately 300 bigrams as compared with approximately three trigrams for each bigram. That is, at the bigram level there is enough information to make implementation of the hierarchical storage structure practical. In one embodiment, the hierarchical structure is used to store bigram information from only those unigrams that have a practically large number of corresponding bigrams. Bigram information for unigrams having an impractically small number of bigrams is stored sequentially in accordance with the prior art.

The method of the present invention may be extended to other index-based search applications having a large number of indexes where each index requires significant storage.

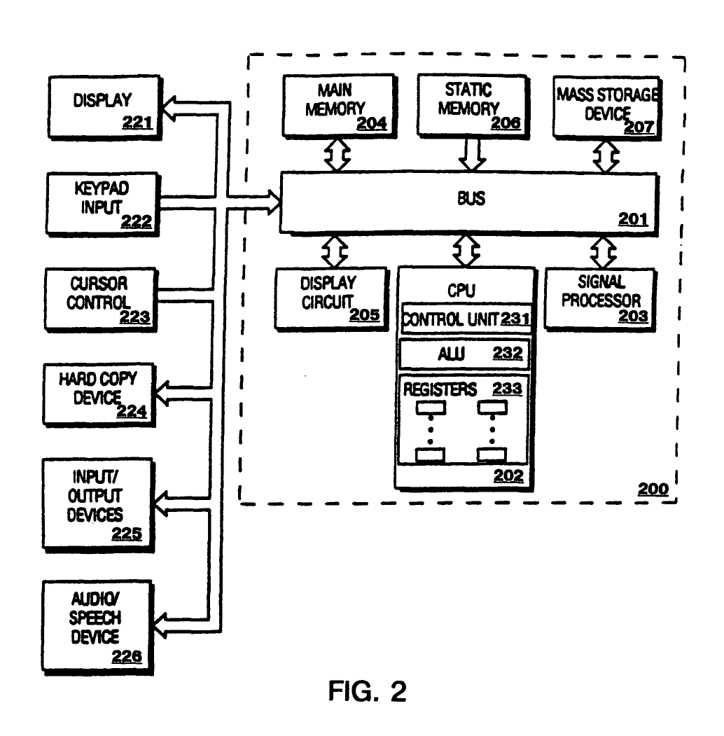

FIG. 2 is a diagram illustrating an exemplary computing system 200 for implementing a language model database for a consecutive speech recognition system in accordance with the present invention. The data storage calculations and comparisons and the hierarchical word index file structure described herein can be implemented and utilized within computing system 200, which can represent a general-purpose computer, portable computer, or other like device. The components of computing system 200 are exemplary in which one or more components can be omitted or added. For example, one or more memory devices can be utilized for computing system 200.

Referring to FIG. 2, computing system 200 includes a central processing unit 202 and a signal processor 203 coupled to a display circuit 205, main memory 204, static memory 206, and mass storage device 207 via bus 201. Computing system 200 can also be coupled to a display 221, keypad input 222, cursor control 223, hard copy device 224, input/output (I/O) devices 225, and audio/speech device 226 via bus 201.

Bus 201 is a standard system bus for communicating information and signals. CPU 202 and signal processor 203 are processing units for computing system 200. CPU 202 or signal processor 203 or both can be used to process information and/or signals for computing system 200. CPU 202 includes a control unit 231, an arithmetic logic unit (ALU) 232, and several registers 233, which are used to process information and signals. Signal processor 203 can also include similar components as CPU 202.

Main memory 204 can be, e.g., a random access memory (RAM) or some other dynamic storage device, for storing information or instructions (program code), which are used by CPU 202 or signal processor 203. Main memory 204 may store temporary variables or other intermediate information during execution of instructions by CPU 202 or signal processor 203. Static memory 206, can be, e.g., a read only memory (ROM) and/or other static storage devices, for storing information or instructions, which can also be used by CPU 202 or signal processor 203. Mass storage device 207 can be, e.g., a hard or floppy disk drive or optical disk drive, for storing information or instructions for computing system 200.

Display 221 can be, e.g., a cathode ray tube (CRT) or liquid crystal display (LCD). Display device 221 displays information or graphics to a user. Computing system 200 can interface with display 221 via display circuit 205. Keypad input 222 is an alphanumeric input device with an analog to digital converter. Cursor control 223 can be, e.g., a mouse, a trackball, or cursor direction keys, for controlling movement of an object on display 221. Hard copy device 224 can be, e.g., a laser printer, for printing information on paper, film, or some other like medium. A number of input/output devices 225 can be coupled to computing system 200. A hierarchical word index file structure in accordance with the present invention can be implemented by hardware and/or software contained within computing system 200. For example, CPU 202 or signal processor 203 can execute code or instructions stored in a machine-readable medium, e.g., main memory 204.

The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media, flash memory devices. The code or instructions may be represented by carrier-wave signals, infrared signals, digital signals, and by other like signals.

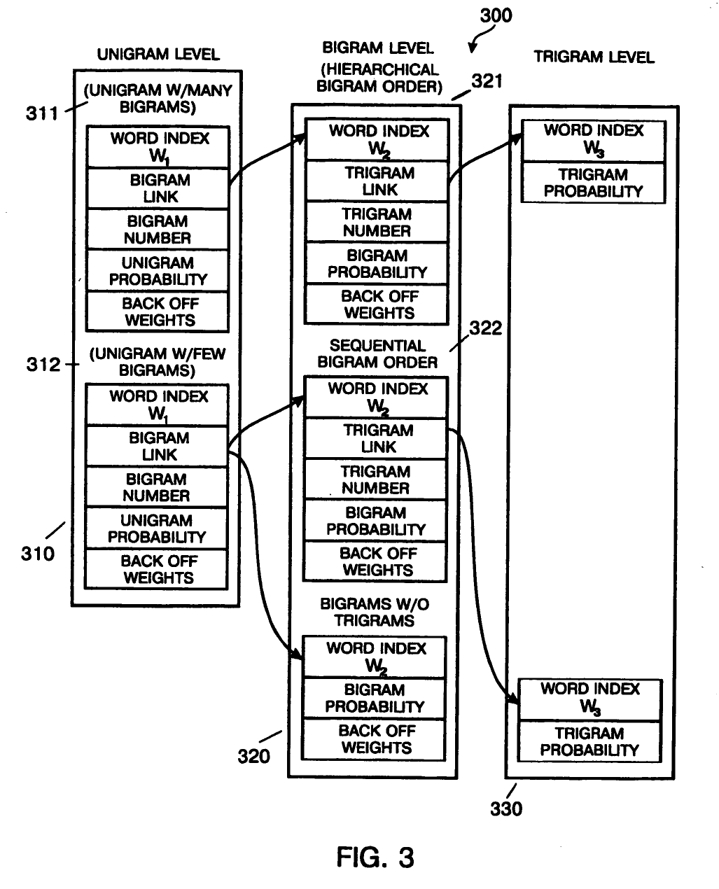

FIG. 3 illustrates a hierarchical storage structure in accordance with one embodiment of the present invention. The hierarchical storage structure 300, shown in FIG. 3, includes a unigram level 310, a bigram level 320, and a trigram level 330.

At the unigram level 310, the unigram probability and backoff weight are both indexes in a value table, and cannot be reduced further.

On average, unigrams have 300 bigrams which makes hierarchical storage practical, but individual unigrams may have too few bigrams to justify the implementation of the hierarchical structure work fields. Unigrams are divided into two groups; unigrams with enough corresponding bigrams to make the hierarchical storage of the bigram data practical 311, and unigrams with too few corresponding bigrams to make hierarchical storage practical 312. For example, for the WSJ task having 19,958 unigrams, 16,738 have enough bigrams to justify hierarchical storage and therefore the bigram information corresponding to these unigrams is stored in hierarchical bigram order 321. Such unigrams contain a bigram link to the hierarchical bigram order 321. The remaining 3,220 unigrams do not have enough bigrams to justify hierarchical storage and therefore the corresponding bigram information is stored in simple sequential order. These unigrams contain a bigram link to the sequential bigram order 322. For a typical text corpus, there are very few unigrams that have no bigrams and they are, therefore, not stored separately.

At the bigram level 320, each bigram (i.e., those with corresponding trigrams) has a link to the trigram level 330. For a typical text corpus there are comparatively more bigrams that do not have trigrams than there are unigrams that do not have bigrams. For example, for the WSJ task having 6,850,083 bigrams, 3,414,195 bigrams have corresponding trigrams, and 3,435,888 bigrams do not have corresponding trigrams. In one embodiment bigrams that have no trigrams are stored separately allowing the elimination of the four-byte trigram link field in those instances.

Typically, the word indexes of bigrams for one unigram are very close to one another. The proximity of these word indexes is a language-specific peculiarity. This distribution of the existing bigram indexes allows the indexes to be divided into groups such that the offset between the first bigram word index and the last bigram word index is less than 256. That is, this offset may be stored in one byte. This allows, for example, a three-byte word index to be represented as the sum of a two-byte base and a one-byte offset. That is, because the two higher order bytes of a word index are repeated for several bigrams, these two bytes can be eliminated from storage for some groups of bigrams. Such storage, in accordance with the present invention allows significant compression at the bigram level. As noted above, this is not the case with bigrams corresponding to every unigram. In accordance with the present invention the storage space is calculated, to determine if it can be reduced through hierarchical storage. If not, the bigram indexes for a particular unigram are stored sequentially in accordance with the prior art.

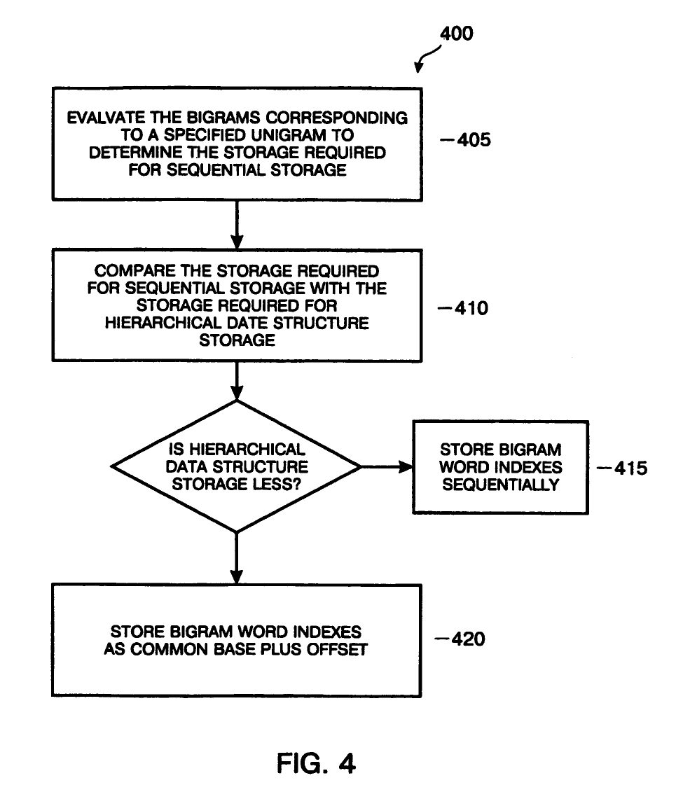

FIG. 4 is a process flow diagram in accordance with one embodiment of the present invention. The process 400, shown in FIG. 4, begins at operation 405 in which the bigrams corresponding to a specified unigram are evaluated to determine the storage required for a simple sequential storage scheme. At operation 410 the storage requirements for sequential storage are compared with the storage requirements for a hierarchical data structure storage. If there is no compression of data (i.e., reduction of storage requirements), then the bigram word indexes are stored sequentially at operation 415. If hierarchical data storage reduces storage requirements, then the bigram word indexes are stored as a common base with a specific offset at operation 420. For example for a three-byte word index, the common base may be two-bytes with a one-byte offset.

The compression rate depends on the number of bigram probabilities in the language model. The language model used in the WSJ task has approximately six million bigram probabilities requiring approximately 97 MB of storage. Implementation of the hierarchical storage structure of the present invention achieved a 32% compression of the bigram indexes that reduced overall storage by 12 MB (i.e., approximately 11% overall reduction). For other language models, the compression rate may be higher. For example, implementing the hierarchical bigram storage structure for the language model for the Chinese language 863 task, compression rates for bigram indexes are approximately 61.8%. This yields an overall compression rate of 26.7% (i.e., 70.3 MB compressed to 51.5 MB). This reduction of the language model data file significantly reduces data storage requirements and data processing time.

The compression technique of the present invention is not practical at the trigram level because there are, on average, only approximately three trigrams per bigram for the language model for the WSJ task. The trigram level also contains no backoff weight or link fields as there is no higher level.

This patent can be extended to use in other structured search scenario, where the word index is the key; each word index requires significant amount of storage; and the number of word indexes is huge.

While the invention has been described in terms of several embodiments and illustrative figures, those skilled in the art will recognize that the invention is not limited to the embodiments or the figures described. In particular, the invention can be practiced in several alternative embodiments that provide a hierarchical data structure to reduce the size of a language model database.

Therefore, it should be understood that the method and apparatus of the invention can be practiced with modification and alteration within the spirit and scope of the appended claims. The description is thus to be regarded as illustrative instead of limiting on the invention.

1. A method for storing a plurality of bigram word indexes corresponding to a specified unigram as a common base with a specific offset characterized in that the bigram word indexes are part of a trigram language model of a consecutive speech recognition system wherein language model models the Wall Street Journal task.

2. The method of claim 1 wherein each bigram word index has a length of three bytes, the common base has a length of two bytes, and the specific offset has a length of one byte.

3. A method for storing a plurality of bigram word indexes, each bigram word index corresponding to a specified unigram as a common base with a specific offset, the bigram word indexes part of a trigram language model of a consecutive speech recognition system wherein language model models the Wall Street Journal task, the method comprising:
determining storage space required for sequential storage of the plurality of bigram word indexes corresponding to a specified unigram;
determining storage space required for hierarchical data structure storage of the plurality of bigram word indexes; and
implementing hierarchical data structure storage of the plurality of bigram word indexes if the storage space required for hierarchical data structure storage of the plurality of bigram word indexes is less than the storage space required for sequential storage of the plurality of bigram word indexes.

4. The method of claim 3 wherein the hierarchical data structure storage of the plurality of bigram word indexes includes storing each bigram word index as a common base with a specific offset.

5. The method of claim 4 wherein each bigram word index has a length of three bytes, the common base has a length of two bytes, and the specific offset has a length of one byte.

6. A machine-readable medium that provides executable instructions which, when executed by a processor, cause the processor to perform a method for storing a plurality of bigram word indexes, the bigram word indexes part of a trigram language model of a consecutive speech recognition system wherein language model models the Wall Street Journal task, the method comprising:
determining storage space required for sequential storage of the plurality of bigram word indexes corresponding to a specified unigram;
determining storage space required for hierarchical data structure storage of the plurality of bigram word indexes; and
implementing hierarchical data structure storage of the plurality of bigram word indexes if the storage space required for hierarchical data structure storage of the plurality of bigram word indexes is less than the storage space required for sequential storage of the plurality of bigram word indexes.

7. The machine-readable medium of claim 6 wherein the hierarchical data structure storage of the bigram word indexes includes storing each bigram word index as a common base with a specific offset.

8. The method of claim 7 wherein each bigram word index has a length of three bytes, the common base has a length of two bytes, and the specific offset has a length of one byte.

9. An apparatus comprising a processor with a memory coupled thereto, characterized in that
the memory has stored therein instructions which, when executed by the processor, cause the processor to (a) determine storage space required for sequential storage of a plurality of bigram word indexes, the bigram word indexes part of a trigram language model of a consecutive speech recognition system wherein language model models the Wall Street Journal task (b) determine storage space required for hierarchical data structure storage of the plurality of bigram word indexes, and (c) implement hierarchical data structure storage of the plurality of bigram word indexes if the storage space required for hierarchical data structure storage of the plurality of bigram word indexes is less than the storage space required for sequential storage of the plurality of bigram word indexes.

10. The apparatus of claim 9 wherein the hierarchical data structure storage of the bigram word indexes includes storing the bigram word indexes corresponding to a specified unigram as a common base with a specific offset.

11. The apparatus of claim 10 wherein the bigram word index has a length of three bytes, the common base has a length of two bytes, and the specific offset has a length of one byte.

12. A method for storing a plurality of bigram word indexes corresponding to a specified unigram as a common base with a specific offset characterized in that the bigram word indexes are part of a trigram language model of a consecutive speech recognition system wherein language model models the Chinese Task 863.

13. The method of claim 12 wherein each bigram word index has a length of three bytes, the common base has a length of two bytes, and the specific offset has a length of one byte.

14. A method for storing a plurality of bigram word indexes, each bigram word index corresponding to a specified unigram as a common base with a specific offset, the bigram word indexes part of a trigram language model of a consecutive speech recognition system wherein language model models the Chinese Task 863, the method comprising:
determining storage space required for sequential storage of the plurality of bigram word indexes corresponding to a specified unigram;
determining storage space required for hierarchical data structure storage of the plurality of bigram word indexes; and
implementing hierarchical data structure storage of the plurality of bigram word indexes if the storage space required for hierarchical data structure storage of the plurality of bigram word indexes is less than the storage space required for sequential storage of the plurality of bigram word indexes.

15. The method of claim 14 wherein the hierarchical data structure storage of the plurality of bigram word indexes includes storing each bigram word index as a common base with a specific offset.

16. The method of claim 15 wherein each bigram word index has a length of three bytes, the common base has a length of two bytes, and the specific offset has a length of one byte.

17. A machine-readable medium that provides executable instructions which, when executed by a processor, cause the processor to perform a method for storing a plurality of bigram word indexes, the bigram word indexes part of a trigram language model of a consecutive speech recognition system wherein language model models the Chinese Task 863, the method comprising:
determining storage space required for sequential storage of the plurality of bigram word indexes corresponding to a specified unigram;
determining storage space required for hierarchical data structure storage of the plurality of bigram word indexes; and
implementing hierarchical data structure storage of the plurality of bigram word indexes if the storage space required for hierarchical data structure storage of the plurality of bigram word indexes is less than the storage space required for sequential storage of the plurality of bigram word indexes.

18. The machine-readable medium of claim 17 wherein the hierarchical data structure storage of the bigram word indexes includes storing each bigram word index as a common base with a specific offset.

19. The method of claim 18 wherein each bigram word index has a length of three bytes, the common base has a length of two bytes, and the specific offset has a length of one byte.

20. An apparatus comprising a processor with a memory coupled thereto, characterized in that
the memory has stored therein instructions which, when executed by the processor, cause the processor to (a) determine storage space required for sequential storage of a plurality of bigram word indexes, the bigram word indexes part of a trigram language model of a consecutive speech recognition system wherein language model models the Chinese Task 863 (b) determine storage space required for hierarchical data structure storage of the plurality of bigram word indexes, and (c) implement hierarchical data structure storage of the plurality of bigram word indexes if the storage space required for hierarchical data structure storage of the plurality of bigram word indexes is less than the storage space required for sequential storage of the plurality of bigram word indexes.

21. The apparatus of claim 20 wherein the hierarchical data structure storage of the bigram word indexes includes storing the bigram word indexes corresponding to a specified unigram as a common base with a specific offset.

22. The apparatus of claim 21 wherein the bigram word index has a length of three bytes, the common base has a length of two bytes, and the specific offset has a length of one byte.
